(19) United States
(12) Patent Application Publication
(10) Pub. No.: US 2006/0175000 A1
(43) Pub. Date: Aug. 10, 2006

(54) Mosaic panel, method and equipment for making the same

(75) Inventor: Valeria Osterwalder, Lugano (CH)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Art Productions Litmited

(21) Appl. No.: 11/206,760

(22) Filed: Aug. 19, 2005

(30) Foreign Application Priority Data
Feb. 10, 2005 (EP) 05002755.6

(51) Int. Cl. B32B 33/00

(52) U.S. Cl. 156/242; 156/500; 428/44

(57) ABSTRACT

A mosaic panel suitable to provide a portion of a mosaic pattern for walls or furniture elements comprising a plurality of tiles joined along the sides by means of a cast of adhesive material suitable to fill the gaps between the tiles. The cast of adhesive material is arranged only along the sides of the tiles. The adhesive material is a single-component silicone that fills the gaps between the tiles and defines a perimetral edge of the panel. The adhesive material is transparent and suitable to make the panel become flexible.

### FILED OF THE INVENTION

The object of the present invention is a mosaic panel, a method and equipment for manufacturing the same.

### BACKGROUND OF THE INVENTION

Particularly, the present invention relates to a panel comprising a plurality of glass tiles and suitable for providing a portion of a mosaic pattern for walls or furniture components. The panels thus provided may be intended either for assembly in order to provide the final mosaic or being inserted inside furniture components such as spotlights, decorative elements, furniture or the like.

The known panels generally consist of a plurality of tiles, preferably made of glass, which are bonded on a netting or back sheet adhering to a panel surface on the planar faces of the tiles (which surface cannot be seen in the assembled configuration of the mosaic). The tiles are arranged on the netting according to a mosaic pattern portion. The panel thus provided is applied to the walls to be decorated by bonding the face corresponding to the netting or back sheet to the wall. The mosaic pattern is defined by applying several panels, each being characterized by a different arrangement of the tiles. The other face of the tiles/panel (the surface at sight in the assembled configuration) may be covered by an adhesive sheet adapted to be removed after the panel has been bonded in position. The tiles/panel sides are free, i.e. the gaps between the tiles and the panels arranged adjacent to each other are empty and can be filled with filler or other suitable material.

The known panels have only one face to be viewed and are specifically intended to cover walls or surfaces in general. Furthermore, if one wishes to highlight the transparency and colour of the glass tiles, for example by means of a light source, the presence of the netting or back sheet may be a drawback. Finally, since the panel is stiffened by the presence of the netting/back sheet and the glue, it becomes difficult to place on curved or uneven surfaces.

The problem at the heart of the present invention is to provide a mosaic panel, together with a method and equipment for manufacturing the same, which have structural and functional characteristics such as to overcome the drawbacks mentioned above with reference to the prior art.

### SUMMARY OF THE INVENTION

This problem is solved by means of a panel in accordance with claim 1.

### BRIEF DESCRIPTION OF THE DRAWINGS

Further characteristics and the advantages of the panel, method and equipment according to the invention will become apparent from the description of preferred exemplary embodiments thereof, which are merely illustrative and non-limiting, with reference to the annexed figures, in which:

FIG. 1 shows a schematic and partial perspective view of equipment according to the present invention in a first operating condition corresponding to a step of the method for manufacturing a panel according to the present invention;

FIG. 2 shows an enlarged detail of the equipment from FIG. 1 in a subsequent operating condition corresponding to a step of the method for manufacturing a panel according to the present invention;

FIGS. 3 to 5 show the equipment from FIG. 1 in various and subsequent operating conditions corresponding to steps of the method for manufacturing a panel according to the present invention;

FIGS. 6 to 7 show an enlarged detail of the equipment from FIG. 1 in various and subsequent operating conditions corresponding to a step of the method for manufacturing a panel according to the present invention;

FIG. 8 illustrates a partially sectioned perspective view of a panel according to the present invention.

### DETAILED DESCRIPTION OF THE PREFERRED EMBODIMENTS OF THE INVENTION

With reference to the above figures, with 10 has been overall designated a mosaic panel suitable to provide a mosaic pattern portion for walls or furniture components and comprising a plurality of tiles 12 that are preferably made of glass. With 12a have been designated the planar or base faces of the tiles, whereas with 12b have been designated the side faces, or more simply, the sides of the tiles.

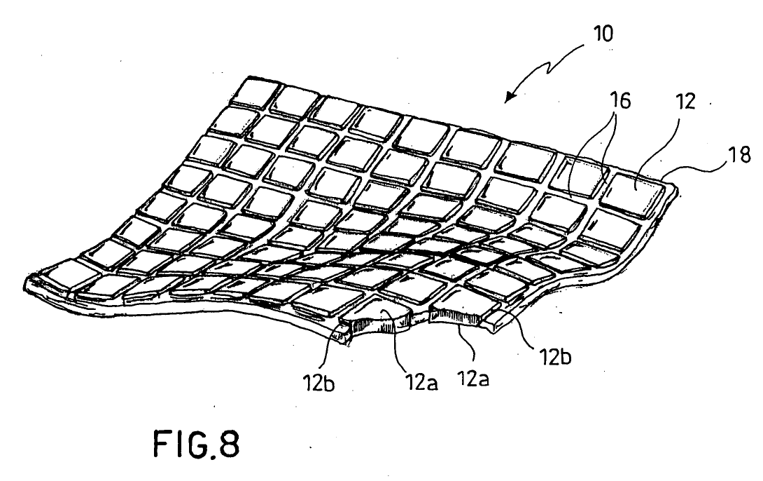

Particularly, FIG. 8 shows a mosaic panel that has been partially sectioned in order to illustrate the connection between the tiles.

The tiles 12 are advantageously linked along the sides by means of a cast of adhesive material 14 suitable to fill at least the gaps between the tiles. In other words, the cast of adhesive material generates seams adhering to the tiles sides, for example by occupying the gaps, or interstices, between adjacent tiles.

Preferably, such as shown in FIG. 8, the cast of adhesive material 14 is arranged only along the tile sides. In other words, the joint of the tiles providing the panel is obtained by means of a grid of adhesive material that adheres to the tiles only along the sides thereof, while leaving the planar faces 12a free.

The adhesive material suitable to provide this joint between the tiles, while at the same time ensuring optimum adherence to the tile (glass) and optimum mechanic strength of the seam adhering to the tile, advantageously comprises a single-component silicone. Still more preferably, this adhesive material substantially consists of a single-component silicone.

A particularly advantageous single-component silicone for the above purpose has a viscosity ranging from 100.000 and 400.000 mPas. This viscosity value allows, in fact, to obtain an optimum self-levelling of the cast along the tile sides. For example, the cast can be caused to flow all along the tile sides down to the bottom, thereby avoiding that the adhesive material may get excessively self-levelled. The optimum viscosity balance allows, in fact, to obtain continuous seams all along the thickness of the gaps between the tiles and optionally an outer perimetral seam having a sufficient thickness, even without using a containment frame, as will be also described below.

In accordance with a possible embodiment, the adhesive material is a single-component silicone having a good adhesion to the tiles (glass) and good physico-chemical properties. This allows one to obtain a seam that does not detach from the tile sides and does not break, even if the panel is folded like a book.

According to a possible embodiment, the single-component silicone has a hardness (DIN 53505) ranging between 20 and 40 Shore A.

In accordance with a possible embodiment, the single-component silicone has an elongation (DIN 53504) ranging between 400 and 800%.

Advantageously, the single-component silicone has a tensile strength (DIN 53504) ranging between 4 and 8 N/mm².

In accordance with a possible embodiment, the single-component silicone has a tearing strength (ASTM D 624) ranging between 13 and 15 N/mm.

Advantageously, the single-component silicone has a density (DIN 53479) ranging between 1,05 e 1,25 g/cm³.

The most advantageous results have been achieved with a single-component silicone exhibiting all the above characteristics. In a particularly advantageous example, the adhesive material comprises, preferably consists of, Elastosil E43® available from Wacker®. In another particularly advantageous example, the adhesive material comprises, preferably consists of, IS 5628E® available from GE BAYER Silicones®.

Such an adhesive material as described above, in addition to the above stated advantages, also has a good temperature resistance, for example in a range of −50° C. to +150° C., as well as an optimum visual appearance.

As already discussed above, by filling the gap between adjacent tiles the adhesive material can be used to join the tiles to one another, and further advantageously provide a perimetral seam adhering to the outer sides of those tiles placed at the edge of the panel. With reference to FIG. 8, with the tiles being in a chessboard arrangement to provide lines and columns, with 16 have been designated the seams made of adhesive material that position along the gaps between the tiles and with 18 have been designated the perimetral seam that, preferably, extends continuously all along the panel edges. As stated above, the adhesive material, preferably single-component silicone, has such characteristics that are suitable to provide both the seams 16 between the tiles and the perimetral seam 18, thereby avoiding the use of containment frames.

The adhesive material thereby fills the gaps between the tiles and defines a perimetral edge of the panel.

Preferably, the adhesive material is transparent, and still more preferably, it is suitable to make the panel become flexible.

In accordance with a possible embodiment, the mosaic panel 10 comprises an adhesive sheet on which, according to a preset pattern, there are positioned the tiles which will be subsequently joined along the sides thereof by means of the cast of adhesive material. Preferably, the adhesive sheet is suitable to be removed before the panel is fixed in position, in order to provide a mosaic pattern portion for walls or furniture components. Still more preferably, the adhesive sheet is water-soluble, preferably water-soluble paper, hence suitable to be removed by means of water.

In accordance with a possible embodiment, the adhesive material defining the cast between the tiles can either comprise or be replaced with other transparent, flexible adhesive materials. A first exemplary embodiment provides the use of mono- or two-component polyurethanes whereas a second exemplary embodiment provides the use of two-component silicones.

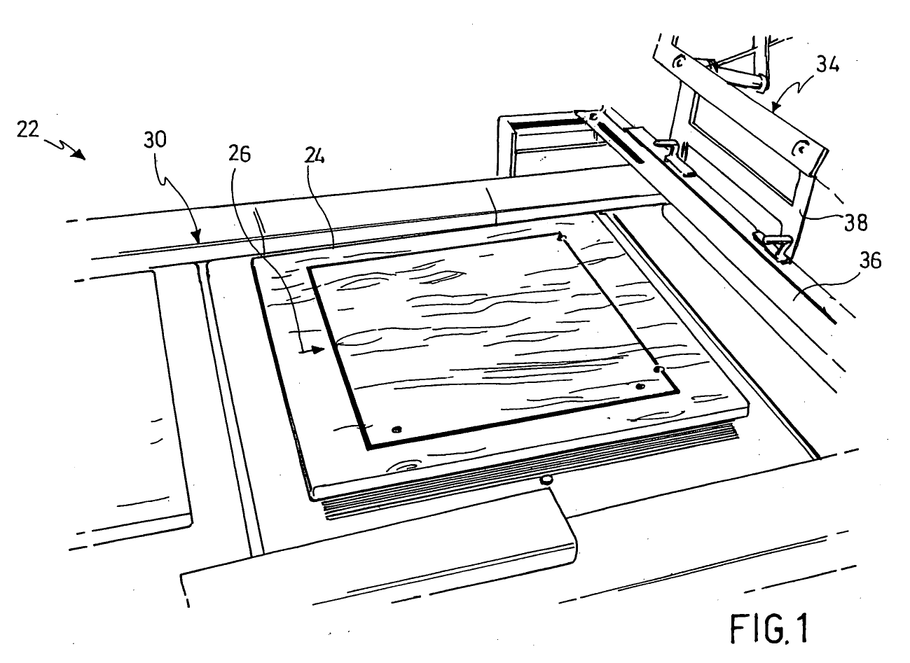

In accordance with an aspect of the present invention, FIGS. 1-7 illustrate equipment 22 for manufacturing a mosaic panel 10 suitable to provide a mosaic pattern portion for walls or furniture components. Particularly, the equipment is suitable to manufacture a panel such as described above.

The equipment according to the present invention comprises one or more support planes 24, preferably made of plain material, such as wood.

The support planes can be mounted on a belt. In this way, the support planes can be moved forward along a path 26 either along several discrete positions or continuously.

A support plane is suitable to receive the tiles of a panel, preferably being already arranged according to the preset pattern by means of the adhesive sheet, and positioned relative to a reference mark 28.

With 30 has been designated a cast station comprising a nozzle 32 suitable to cast the adhesive material along the sides 12b of the tiles. This nozzle is movable relative to the support plane for example as a function of the reference mark on the panel support plane, the size and optionally the shape thereof, in order to fill the gaps between the tiles.

In accordance with a possible embodiment, the tiles are placed on the support plane 24 in an established position relative to the reference mark 28 such as defined by a reference element 34 that is movable relative to the support plane.

Advantageously, the reference element 34 is movable relative to the support plane 24 between a work position and a rest position, by pivoting about an axis A-A parallel to the support plane.

In accordance with a possible embodiment, the reference element 34 comprises an L-shaped element defining the position of a corner of the panel.

Preferably, the reference element 34 is connected to a cross-piece 36 that is arranged transversal to the forward direction of the support plane along the equipment (path 26).

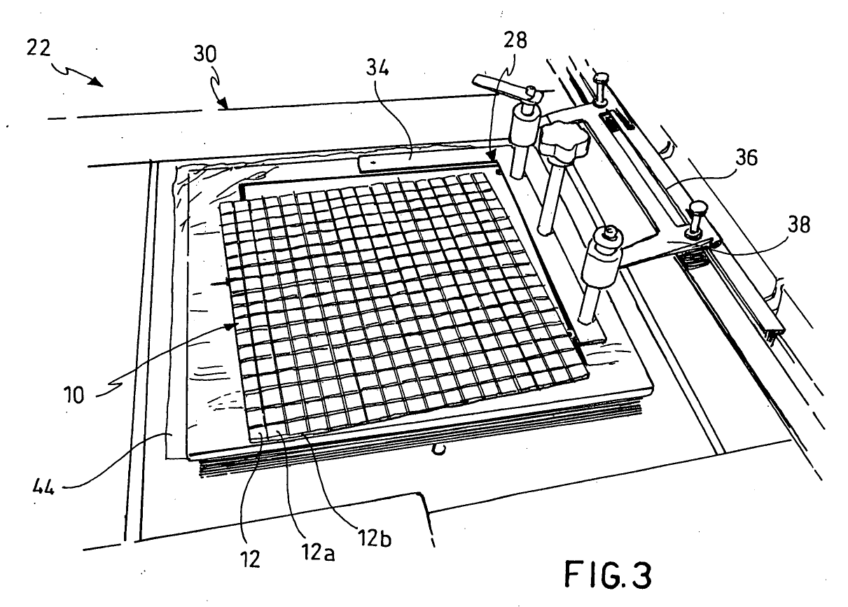

For example, in FIG. 3 there is illustrated the work position of an L-shaped reference element 34 being connected to the cross-piece 36 by means of arms 38. The arms 38 are hinged to the cross-piece 36 thereby defining the axis A-A parallel to the cross-piece.

In accordance with a possible embodiment, the nozzle 32 is suitable to move along a path where the adhesive material is cast both along the sides of the tiles in order to fill the gaps between the tiles and along the sides of the tiles as well, in order to define a perimetral edge of the panel. Advantageously, the nozzle is suitable to be moved along a path where the adhesive material is first cast along the perimetral edge of the panel then along the tiles sides as the filler of the gaps, and particularly first along those gaps being arranged transversal to the forward direction of the panel towards the cast station (path 26) and finally along those gaps being arranged parallel to this forward direction.

Advantageously, the nozzle 32 is suitable to be moved along a path parallel to the support plane 24 and preferably along axes perpendicular to each other that define controlled movement axes for the nozzle.

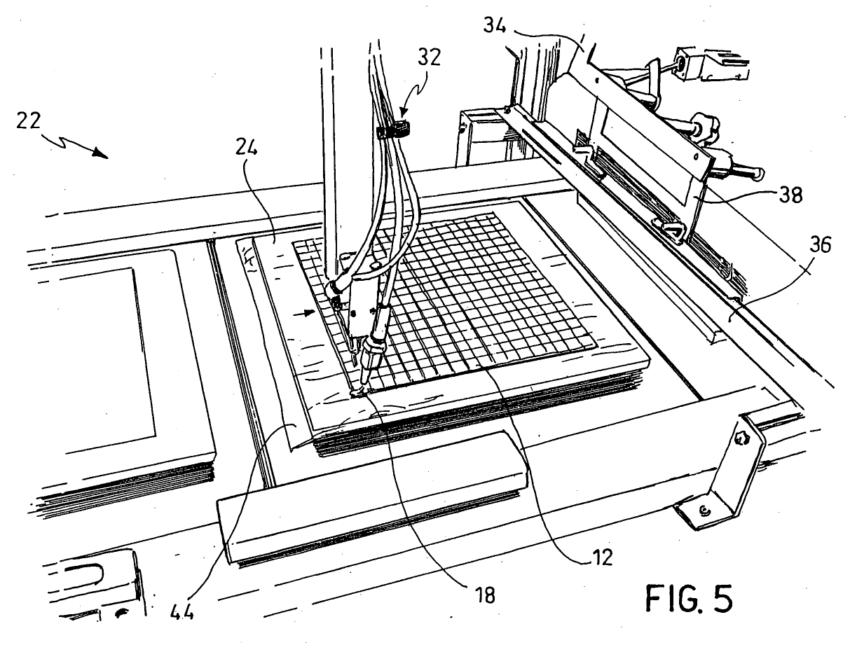

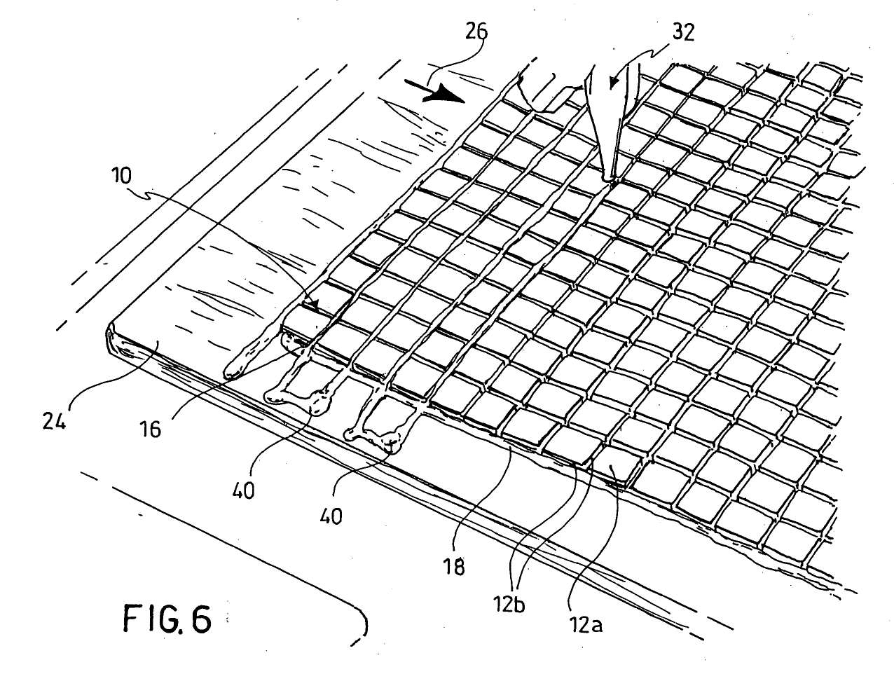

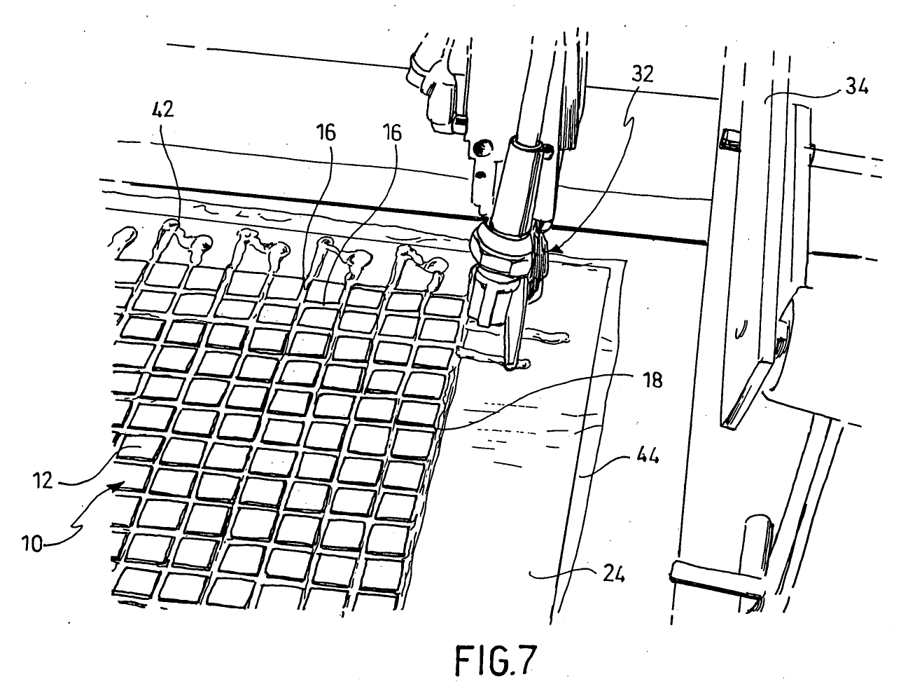

FIG. 5 illustrates an exemplary movement of the nozzle in which the cast of adhesive material starts from a corner of the panel in order to form the perimetral seam 18. In FIG. 6, the perimetral seam 18 has been completed and the nozzle 32 is moved for the adhesive material to be cast along the gaps being arranged transversal to the forward direction of the support plane. The cast can be carried out continuously, by moving further beyond the limit defined by the perimetral seam and forming waste portions 40 corresponding to the nozzle shifting from a gap to the next one. Optionally, a nozzle carrying out a discontinuous cast can be provided. After the seams transversal to the forward direction have been completed, the nozzle is moved in order to cast the adhesive material along the gaps between the tiles arranged along the forward direction of the support plane (FIG. 7). Also in this case, the cast can be carried out continuously by moving further beyond the limit defined by the perimetral seam and forming waste portions 42 corresponding to the nozzle shifting from a gap to the next one.

In accordance with a possible embodiment, the support plane 24 comprises a sheet 44 made of plastic material suitable to receive the panel and avoid that the adhesive material may stick to the support plane. Preferably, the sheet 44 is made of polyethylene. When using such a sheet, a support plane made of a plain material such as wood can be arranged, since the adhesive material does not stick thereto, such that the support plane can be easily cleaned.

In the case where the panel comprises a preferably water-soluble adhesive sheet, the equipment according to the invention comprises a station for detaching this adhesive sheet of the panel after the adhesive material cast between the tiles has hardened. In the case of a water-soluble adhesive sheet, this station advantageously comprises water supply means (not shown) for eliminating the water-soluble sheet.

In accordance with a further aspect, the present invention relates to a method for manufacturing a mosaic panel suitable to provide a mosaic pattern portion for walls or furniture components. Particularly, this method is suitable to manufacture a panel such as described above.

According to a general aspect of the invention, said method comprises the steps of positioning the tiles according to the panel pattern arrangement and laying them on a support plane 24 in a preset position relative to a reference mark 28 on the support plane and casting the adhesive material along the tiles sides by moving a nozzle 32 as a function of, for example, the reference mark 28 on the support plane of the panel, the number of tiles and size thereof in order to fill the gaps between the tiles.

In accordance with a possible embodiment, the panel is laid on a sheet 44 made of plastic material, preferably a polyethylene sheet, being arranged on the support plane.

According to a possible embodiment, the reference mark is defined by a reference element 34 that is movable relative to the support plane, between a work position and a rest position, preferably by pivoting about an axis parallel to the support plane.

Preferably, the adhesive material is cast both along the sides of the tiles in order to fill the gaps between the tiles and along those sides of the tiles corresponding to a perimetral edge of the panel. For example, the adhesive material is first cast along the perimetral edge of the panel, then along the sides of the tiles as a gap filler, preferably before along the gaps being arranged transversal to a forward direction of the panel towards a cast station, and finally along the gaps being arranged parallel to a forward direction of the panel towards a cast station.

According to an aspect of the invention, before being positioned on the support plane for the cast, the tiles are positioned on an adhesive sheet according to the panel pattern arrangement, particularly on the side suitable to come in contact with the support plane. Advantageously, the tiles are positioned on a water-soluble adhesive sheet.

In accordance with a possible embodiment, the panel is washed with water in order to detach the water-soluble adhesive sheet after the adhesive material cast between the tiles has hardened.

With reference to FIGS. 1-7, the operation of an equipment according to the present invention and a corresponding embodiment of a method according to the present invention will be described below.

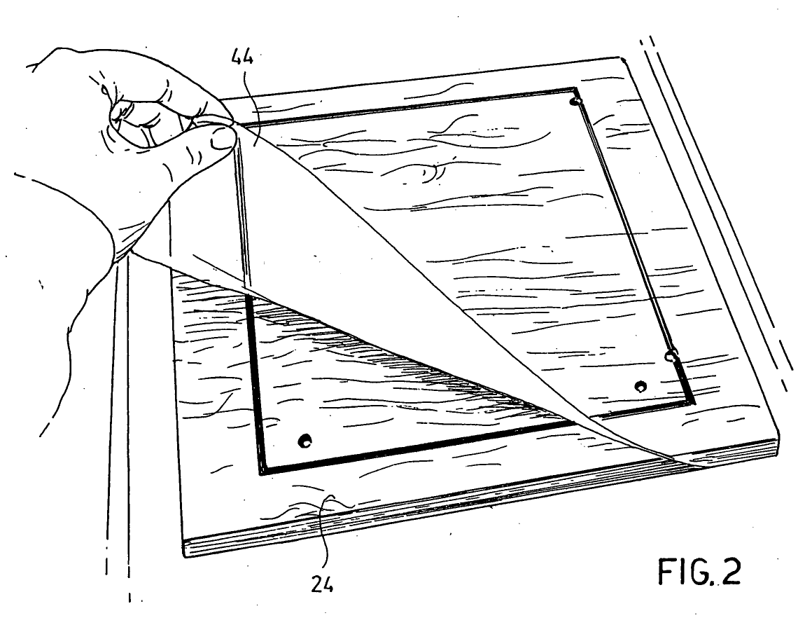

With reference to FIG. 1, the support plane 24 is moved along the path 26 until reaching the cast station, at the reference element 34. With reference to FIG. 2, the sheet 44, preferably made of polyethylene, if present, is positioned on the support plane 24.

With reference to FIG. 3, the reference element 34 is moved from the rest position to the work position where it rests on the support plane and defines the reference mark 28. The tiles 12, being optionally arranged on the adhesive sheet, are rested on the support plane 24 in a preset position relative to the reference mark 28. For example, a corner of panel 10 is caused to contact the L-shaped reference element 34.

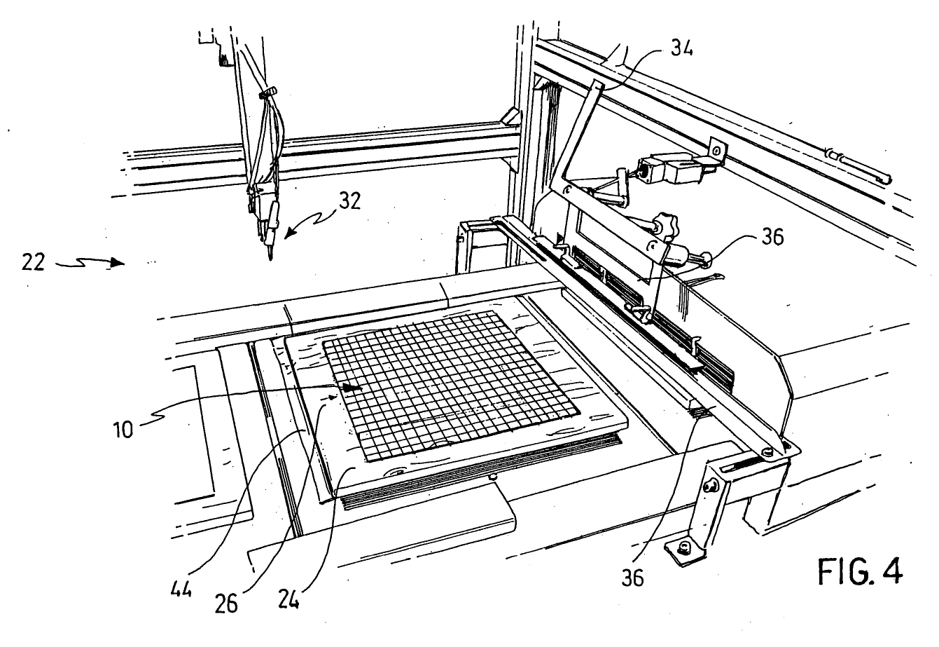

Before the cast, the reference element 34 is moved from the work position to the rest position (FIG. 4) such that the nozzle 32 can be moved relative to the support plane 24.

FIG. 5 illustrates the beginning of the cast, from the perimetral seam 18 which is continuously cast on all outer sides of the panel. Due to the optimum viscosity degree of the adhesive material, the perimetral seam 18 can be cast without containment frames.

With reference to FIG. 6, after the cast of the perimetral seam 18 has been completed, there starts the cast of the seams 16 between the tiles, for example starting from those being arranged transversal to the forward direction of the support plane 24 (path 26). The cast of the seams 16 is also carried out continuously, the nozzle 32 being expected to move further beyond the perimetral seam 18 thereby generating a waste portion 40 corresponding to the shifting from a gap to the next one.

With reference to FIG. 7, after the cast of adhesive material along the gaps being transversal to the forward direction of the support plane has been completed, the nozzle 32 is moved to start the cast of the adhesive material along the gaps being arranged according to the forward direction of the support plane in order to form further seams 16 intersecting the ones previously made. Also in this case, the nozzle 32 is advantageously expected to move further beyond the perimetral seam 18 thereby generating a waste portion while shifting from a gap to the adjacent one.

Subsequent to the steps illustrated, the adhesive material is left to harden. Subsequently, the adhesive sheet on which the tiles had been previously arranged, when present, is eliminated. In the case of a water-soluble adhesive paper sheet, this steps advantageously provides using water.

After the adhesive material has hardened, the waste portions 40 and 42 are eliminated and optionally also the perimetral seam 18 is trimmed parallel to the panel edge.

The panel thus obtained can be used as a tile for making mosaics on walls, floors or other structures.

Furthermore, the panel according to the present invention can be used for making furniture components, decorative elements, spotlights or the like, for example by exploiting the characteristics of transparency, brightness, temperature resistance, mechanical strength, and flexibility.

Upon application, the panel can either be bonded on a support wall, or directly used at sight on both sides thereof.

>From what has been stated above, it may be appreciated that providing a panel according to the invention allows to obtain a very versatile element that is suitable to a variety of applications, both traditional and innovative.

The original arrangement and selection of the adhesive material allows to provide a particularly resistant panel, preferably flexible and transparent, in which both faces can be at sight.

The adhesive material originally selected combines resistance characteristics suitable for the application and adhesion of the tiles along their sides, thereby avoiding being forced to bond the planar faces of the tiles.

Particularly, the selected adhesive material allows to make the seams, both the perimetral one and those between the tiles, thereby avoiding the use of outer frames and at the same time ensuring optimum adhesion of the tiles and efficient self-levelling of the adhesive material.

According to a possible variant embodiment, the method according to the present invention is carried out by means of a manual equipment, a gun being provided for injecting the adhesive material, preferably the single-component silicone, along the sides of the tiles.

To the preferred embodiment of the invention such as described above, those skilled in the art, aiming at satisfying contingent and specific requirements, may carry out a number of modifications, adaptations and replacements of elements with functionally equivalent ones, without however departing form the scope of the claims below.

1. A mosaic panel suitable to provide a portion of a mosaic pattern for walls or furniture elements comprising a plurality of tiles being joined along the sides by means of a cast of adhesive material suitable to fill at least the gaps between the tiles.

2. The mosaic panel according to claim 1, wherein the cast of adhesive material is arranged only along the sides of the tiles.

3. The mosaic panel according to claim 2, wherein the adhesive material is a single-component silicone.

4. The mosaic panel according to claim 3, wherein said single-component silicone has a viscosity ranging between 100.000 and 400.000 mPas.

5. The mosaic panel according to claim 3, wherein said single-component silicone has a hardness ranging between 20 and 40 Shore A.

6. The mosaic panel according to claim 3, wherein said single-component silicone has an elongation ranging between 400 and 800%.

7. The mosaic panel according to claim 3, wherein said single-component silicone has a tensile strength ranging between 4 and 8 N/mm².

8. The mosaic panel according to claim 3, wherein said single-component silicone has a tearing strength ranging between 13 and 15 N/mm.

9. The mosaic panel according to claim 3, wherein said single-component silicone has a density ranging between 1.05 and 1.25 g/cm³.

10. The mosaic panel according to claim 3, wherein said single-component silicone has a curing time at 23° C. and in the presence of 50% humidity ranging between 10 and 25 minutes.

11. The mosaic panel according to claim 3, wherein said single-component silicone comprises Elastosil E43® available from Wacker®.

12. The mosaic panel according to claim 11, wherein said single-component silicone consists of Elastosil E43® available from Wacker®

13. The mosaic panel according to claim 3, wherein said single-component silicone comprises IS 5628E® available from GE BAYER Silicones®.

14. The mosaic panel according to claim 13, wherein said single-component silicone consists of IS 5628E® available from GE BAYER Silicones®.

15. The mosaic panel according to claim 1, wherein the adhesive material fills the gaps between the tiles and defines a perimetral edge (18) of the panel.

16. The mosaic panel according to claim 1, wherein the adhesive material is transparent.

17. The mosaic panel according to claim 1, wherein the adhesive material is suitable to make the panel become flexible.

18. The mosaic panel according to claim 16, wherein said adhesive material comprises a two-component silicone.

19. The mosaic panel according to claim 16, wherein said adhesive material comprises a single- or two-component polyurethane.

20. The mosaic panel according to claim 1 comprising an adhesive sheet on which there are positioned the tiles in order to be joined along the sides by means of said cast of adhesive material.

21. The mosaic panel according to claim 20, wherein said adhesive sheet is suitable to be removed before the panel is fixed in position, in order to provide a mosaic pattern portion for walls or furniture components.

22. The mosaic panel according to claim 20, wherein said adhesive sheet is water-soluble.

23. The mosaic panel according to claim 21, wherein said adhesive sheet is water-soluble.

24. The mosaic panel according to claim 17, wherein said adhesive material comprises a two-component silicone.

25. The mosaic panel according to claim 17, wherein said adhesive material comprises a single- or two-component polyurethane.

26. A method for making a mosaic panel suitable to provide a mosaic pattern portion for walls or furniture components according to claim 1, said method comprising the steps of:
positioning the tiles according to the panel pattern arrangement and laying them on a support plane;
casting the adhesive material along the sides of the tiles for the latter to be joined along their sides, said cast of adhesive material being suitable to fill at least the gaps between the tiles.

27. The method for making a mosaic panel according to claim 26, comprising the steps of:
positioning the tiles according to the panel pattern arrangement and laying them on the support plane at a preset position relative to a reference mark on the support plane;
casting the adhesive material along the sides of the tiles by moving a nozzle as a function of the reference mark on the support plane of the panel, the number of tiles, the size and shape thereof in order to fill the gaps between the tiles.

28. The method for making a mosaic panel according to claim 26, wherein the adhesive material is cast both along the sides of the tiles to fill the gaps between the tiles and along the sides of the tiles corresponding to a perimetral edge of the panel.

29. The method for making a mosaic panel according to claim 28, wherein the adhesive material is first cast along the perimetral edge of the panel, then along the sides of the tiles as a gap filler.

30. The method for making a mosaic panel according to claim 29, wherein the adhesive material is first cast along the perimetral edge of the panel then along the gaps being arranged transversal to a forward direction of the panel towards a cast station and finally along the gaps being arranged parallel to a forward direction of the panel towards a cast station.

31. The method for making a mosaic panel according to claim 26, wherein, before being positioned on the support plane for the cast, the tiles are positioned on an adhesive sheet according to the panel pattern arrangement.

32. The method for making a mosaic panel according to claim 31, wherein before being positioned on the support plane for the cast, the tiles are positioned on the adhesive sheet on the side suitable to get in contact with the support plane.

33. The method for making a mosaic panel according to claim 31, wherein before being positioned on the support plane for the cast, the tiles are positioned on a water-soluble adhesive sheet.

34. The method for making a mosaic panel according to claim 33, wherein the panel is washed with water to remove the water-soluble adhesive sheet after the adhesive material cast between the tiles has hardened.

35. The method for making a mosaic panel according to claim 26, wherein the panel is laid on a sheet made of plastic material being arranged on the support plane.

36. The method for making a mosaic panel according to claim 35, wherein the panel is laid on a sheet made of polyethylene being arranged on the support plane.

37. The method for making a mosaic panel according to claim 26, wherein the tiles are laid in a preset position relative to a reference mark on the support plane, said reference mark being defined by a reference element movable relative to the support plane.

38. The method for making a mosaic panel according to claim 36, wherein said reference element is movable relative to the support plane between a work position and a rest position by pivoting around an axis parallel to the support plane.

39. Equipment for making a mosaic panel suitable to make a mosaic pattern portion for walls or furniture components, said equipment comprising:
a support plane for the tiles of the panel;
a cast station comprising a nozzle suitable to cast the adhesive material along the sides of the tiles to fill the gaps between the tiles.

40. Equipment for making a mosaic panel according to claim 39, comprising:
a support plane for the tiles of the panel, a reference mark being definable thereon;
a cast station comprising a nozzle suitable to cast the adhesive material along the sides of the tiles, said nozzle being movable relative to the support plane as a function of the reference mark on the support plane of the panel, the number of tiles and the size thereof in order to fill the gaps between the tiles.

41. Equipment for making a mosaic panel according to claim 39, wherein the tiles are laid in a preset position relative to a reference on the support plane, said reference being defined by a reference element movable relative to the support plane.

42. Equipment for making a mosaic panel according to claim 41, wherein said reference element is movable relative to the support plane between a work position and a rest position by pivoting around an axis parallel to the support plane.

43. Equipment for making a mosaic panel according to claim 42, wherein said reference element comprises an L-shaped element for defining the position of a corner of panel.

44. Equipment for making a mosaic panel according to claim 41, wherein said reference element is connected to a cross-piece being arranged transversal to a forward direction of the support plane along the equipment.

45. Equipment for making a mosaic panel according to claim 39, wherein said nozzle is suitable to move along a path where the adhesive material is cast both along the sides of the tiles in order to fill the gaps between the tiles and along the sides of the tiles in order to define a perimetral edge of the panel.

46. The method for making a mosaic panel according to claim 45, wherein the adhesive material is first cast along the perimetral edge of the panel, then along the sides of the tiles as a gap filler.

47. Equipment for making a mosaic panel according to claim 46, wherein the nozzle is suitable to be moved along a path where the adhesive material is first cast along the perimetral edge of the panel then along the gaps arranged transversal to a forward direction of the panel towards the cast station and finally along the gaps arranged parallel to a forward direction of the panel towards the cast station.

48. Equipment for making a mosaic panel according to claim 39, wherein the nozzle is suitable to be moved along a path parallel to the support plane.

49. Equipment for making a mosaic panel according to claim 39, wherein the nozzle is suitable to be moved along axes perpendicular to each other, which define controlled movement axes for the nozzle.

50. Equipment for making a mosaic panel according to claim 39, wherein said support plane comprises a sheet made of plastic material suitable to receive the panel.

51. Equipment for making a mosaic panel according to claim 50, wherein said support plane comprises a sheet made of polyethylene suitable to receive the panel.

52. Equipment for making a mosaic panel according to claim 39, wherein said support plane is movable at least along discrete positions within the equipment.

53. Equipment for making a mosaic panel according to claim 39, comprising a station for removing an adhesive sheet of the panel after the adhesive material cast between the tiles has hardened.

54. Equipment for making a mosaic panel according to claim 53, wherein the station for removing the adhesive sheet of the panel comprises water supply means for eliminating the water-soluble adhesive sheet.
